(19) United States
(12) Patent Application Publication
(10) Pub. No.: US 2013/0169413 A1
(43) Pub. Date: Jul. 4, 2013

(54) METHOD AND SYSTEM FOR DETECTING AN ITEM BEING REMOVED FROM AN ESTABLISHMENT WITHOUT AUTHORIZATION USING RADIO FREQUENCY IDENTIFICATION

(71) Applicant: FREDERICK SCHUESSLER, BAITING HOLLOW, NY (US)

(72) Inventor: FREDERICK SCHUESSLER, BAITING HOLLOW, NY (US)

(73) Assignee: SYMBOL TECHNOLOGIES, INC., HOLTSVILLE, NY (US)

(21) Appl. No.: 13/338,975

(22) Filed: Dec. 28, 2011

(51) Int. Cl. G06K 7/01

(52) U.S. Cl. 340/10.1

(57) ABSTRACT

An electronic article surveillance (EAS) exit portal interrogates a radio frequency identification (RFID) tag affixed to an item that is being removed from the establishment, and attempts to interrogate an EAS pass having an outbound list that stores a set of item identifiers, wherein each item identifier on the outbound list is derived from a RFID tag that is affixed to an item that is authorized for removal. The EAS exit portal detects an unauthorized removal of the item by determining that an item identifier derived from the RFID tag affixed to the item being removed from the establishment is not found on the outbound list of the EAS pass.

### FIELD OF THE DISCLOSURE

The present disclosure relates generally to interrogation of radio frequency identification (RFID) tags, and more particularly, to optimizing interrogation of RFID tags affixed to items, when these RFID tags are used for detecting an item being removed from an establishment without authorization.

### BACKGROUND

RFID systems have become increasingly prevalent and can be used to identify people as well as objects. An RFID system may be configured to include at least one RFID reader (also referred to herein as reader) and one or more RFID tags (also referred to herein as tags). The RFID reader transmits radio frequency (RF) signals to and receives RF signals from one or more tags within a range defined by one or more parameters. For example, the reader's RF range or coverage area may be defined based on an antenna configuration on the reader, the RF characteristics of the area around the reader (e.g., empty space vs. metal obstructions), or the transmit power of the reader. RFID tags are typically compact and are attachable to objects. RFID tags are configured to include an integrated circuit for storing and processing information, modulating and demodulating RF signals, and performing other specialized functions. RFID tags may include an antenna in communication with the integrated circuit, wherein the antenna is used for transmitting RF signals to and receiving RF signals from the RFID reader. An RFID tag is usually tuned to a particular frequency.

In order to keep track of items sold by a retail establishment, the establishment would typically hand-scan optical bar codes on the items' labels. This inventory processing does not in itself provide loss-prevention capabilities, and so the items will also need to be tracked by an Electronic Article Surveillance (EAS) system, with no connection to the inventory system. Legacy EAS systems require that a single-bit EAS tag is affixed to each item. In these systems, when an item with the EAS tag is sold, the bit on the EAS tag is changed. For example, the bit may be switched off so that when the item is carried through an exit, a reader at the exit will not be able to communicate with the EAS tag, and thus will only detect items that were not properly deactivated at a Point of Sale (PoS) system.

However, many establishments are moving towards a more automated inventory approach, by attaching RFID tags to items in inventory. In many cases, the bar codes are being replaced with RFID identity tags that include an Electronic Product Code (EPC). These tags also provide other information (usually by using the EPC as a database key) about the items to which they are affixed, for example, for logistics and inventory control purposes. These identity RFID tags, unlike traditional EAS tags, indicate a unique EPC identity of each item, and therefore offer opportunities for improved loss-prevention systems, in that an exit portal reader will not only detect that an unsold item is present, but will know exactly which item is unsold.

To accurately detect un-purchased items with affixed identity RFID tags, one known implementation requires that the retail establishment have an up-to-date database of every item in its inventory, wherein the database is updated every time an item is sold. In this implementation, a reader at the exit (also referred to herein as an EAS Exit Portal) of the retail establishment is required to have real-time continuous connectivity to the database of all unsold inventory. The database must immediately be updated, for example, within two seconds, when an item is sold at the PoS system in the retail establishment. By maintaining real-time connection between the EAS Exit Portal and the updated inventory database, the EAS Exit Portal will identify those tagged items that are still in the retailer's inventory, which means that they are being removed from the retail establishment without being purchased. However, many retailers find the requirement of continuous connection between the EAS Exit Portal and the updated inventory database to be impractical.

Another implementation known in the art requires that additional information (above and beyond EPC identity) be stored in a memory of every item-level RFID tag. The additional information is to be updated on the item-level RFID tag, to “deactivate” the tag when the item attached to the tag is sold at the PoS system. This information may include details of the transaction, or may be only a single bit, for example, in the case of an item level RFID tag that combines an RFID identity element with a traditional EAS 1-bit memory element indicating sold or unsold status. Adding this capability to alter tags when sold increases the complexity and cost of item-level tags, especially because this requires write operations that must be, for example, password protected to prevent unauthorized updates of the additional information to the item-level RFID tags. Furthermore, if the PoS system deactivation process fails when an item is being purchased, the PoS system will fail to update the item-level RFID tag, and when the tag is carried through the exit, the EAS Exit Portal will issue a false alarm. Although an interrogator/reader in the PoS system will most likely detect deactivation failures, there is no communications channel by which a PoS interrogator/reader can report such failures to a Point of Exit (PoE) reader, such as the EAS Exit Portal, to suppress the alarm.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an example block diagram of an RFID system used in accordance with some embodiments.

FIG. 2 is an example block diagram of an RFID reader used in accordance with some embodiments.

FIG. 3 is an example block diagram of an RFID tag used in accordance with some embodiments.

FIG. 4 is an example block diagram of an EAS pass used in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Generally speaking, pursuant to the various embodiments, the present disclosure provides methods and systems for detecting an item being removed from an establishment without authorization. In accordance with the present teachings of the disclosure, the EAS exit portal interrogates a RFID tag affixed to an item that is being removed from an establishment. The EAS exit portal also attempts to interrogate an EAS pass having an outbound list that stores a set of item identifiers, wherein each item identifier on the outbound list is derived from a RFID tag that is affixed to an item that is authorized for removal from the establishment. The EAS exit portal detects an unauthorized removal of the item by determining that an item identifier derived from the RFID tag affixed to the item being removed from the establishment is not found on the outbound list of the EAS pass. Optionally, in some embodiments, the EAS exit portal may further detect an unauthorized removal of the item by determining that the RFID tag affixed to the item being removed is not altered in such a manner to indicate the item is authorized for removal from the establishment.

Stating the present teachings from a different perspective, when a transaction occurs that should result in an authorization to remove an item from an establishment (for example, at the point of sale), a transacting reader stores an item identifier derived from an RFID tag affixed to the item authorized for removal on an outbound list of an EAS pass. An EAS exit portal attempts to interrogate the EAS pass and at least one RFID tag being removed from the establishment. The EAS exit portal detects removal of an item unauthorized for removal from the establishment by determining that an item identifier derived from the RFID tag affixed to the item unauthorized for removal is not found on the outbound list of the EAS pass. Optionally, in some embodiments, the EAS exit portal may further detect removal of an item unauthorized for removal from the establishment by determining that the RFID tag affixed to the item unauthorized for removal is not altered to indicate that the item is authorized for removal from the establishment. In yet other embodiments, the transacting reader may optionally reduce the size of the outbound list, by storing identifiers for only those items whose tags were not altered to indicate that the item is authorized for removal (as described in more detail below).

As such, the present teachings do not require a continuous connection to a real-time inventory database. It is important to note that even though the present teachings generally refers to “interrogating” the EAS pass, depending on the form in which the EAS pass is embodied (e.g., a RFID tag, a bar code, a magnetic stripe, an electronic circuit, etc.), for the purposes of the present disclosure, the term “interrogating” also encompasses simply “reading” information from the EAS pass.

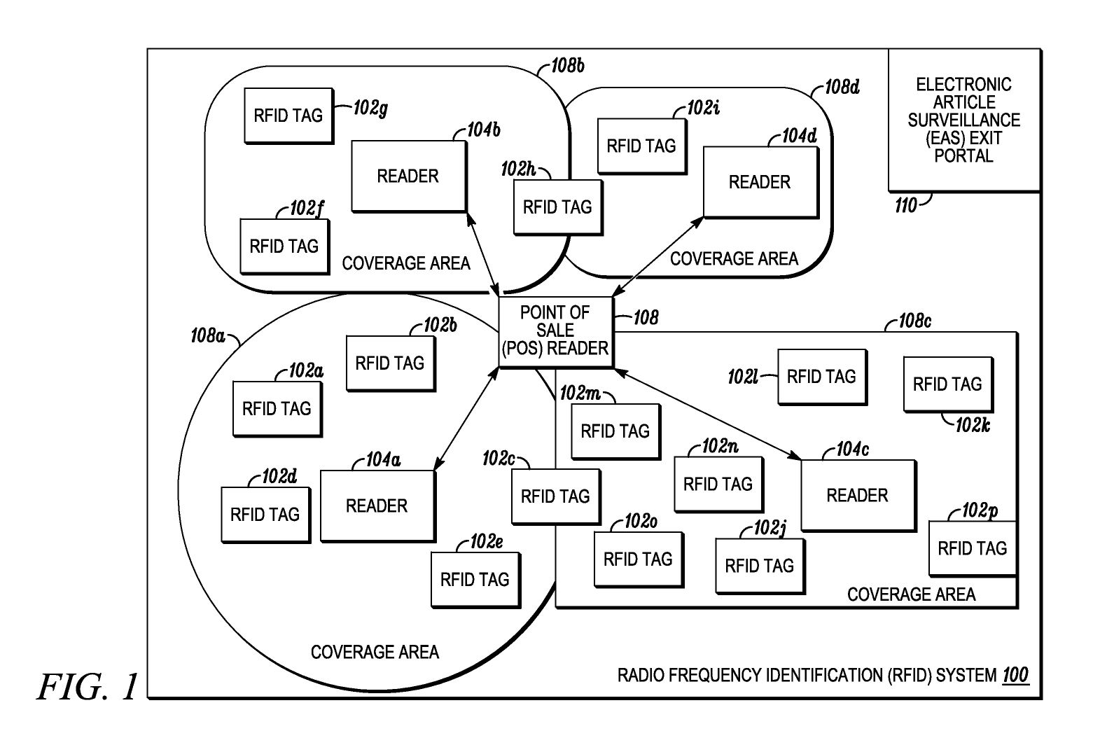

Let us now turn to the figures to describe the present teachings of the disclosure in greater detail. FIG. 1 is a block diagram of an RFID system used in accordance with the present disclosure. RFID system 100 includes RFID readers 104 (also referred to herein as readers 104), each of which transmits RF signals to and receives RF signals from one or more tags within a coverage area. Readers 104 may operate independently or they may be coupled together to form a reader network. Each reader 104 communicates with one or more RFID tags 102 (also referred to herein as tags 102), within its predefined coverage area. An RFID tag 102 may be affixed or attached to an individual item or a group of items in order to determine an inventory of items within an establishment. Each RFID tag 102 conveys identifying information, for example, a number associated with an item, wherein the identifying information is used in conjunction with other information to identify the type of item to which the tag is attached or affixed so that an inventory determination can be quickly accomplished through RFID interrogation.

Each reader 104 may interrogate RFID tags 102 within its coverage area 108 by transmitting an interrogation signal to the RFID tags within the reader's coverage area. RFID tags 102 within the reader's coverage area may transmit one or more response signals to the reader in a variety of ways, including but not limited to, alternatively reflecting and absorbing portions of the interrogation signal according to a time-based pattern or frequency.

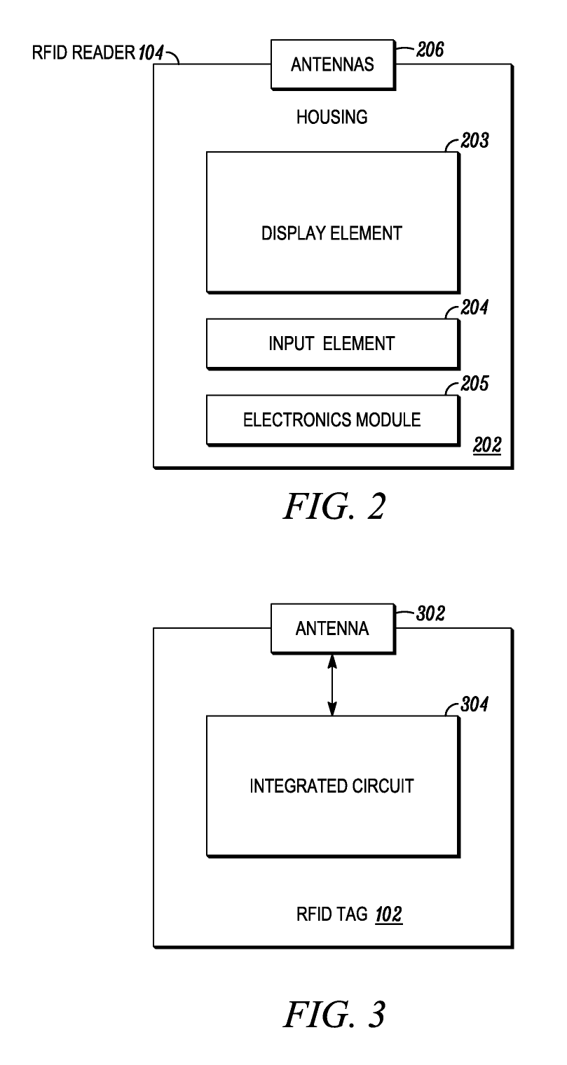

FIG. 2 is a block diagram of an RFID reader used in accordance with some embodiments of the present disclosure. RFID reader 104 generally includes a housing 202, a display element 203 that is visible from the outside of the housing 202, an input element 204 that is accessible from the outside of the housing 202, an electronics module 205 contained within the housing 202, and one or more RFID antenna 206 (which can be, but is not necessarily, contained within the housing 202). The input element 204 may be a keypad, a touch panel or other input/output elements. The display element 203 and the input element 204 function as input/output elements during use of the RFID reader 104. The display element 203 and the input element 204 may be coupled to the electronics module 205, as necessary, to support input/output functions in a conventional manner. The electronics module 205 may incorporate hardware components and software functionality of the RFID reader 104. In some embodiments, the electronics module 205 can be physically realized as an integrated component, board, card, or package mounted within the housing 202. The electronics module 205 may include one or more memory portions for storing instructions, wherein one or more of the memory portions are coupled to one or more processors for performing functions associated with the RFID reader 104. The electronics module 205 can be coupled to the RFID antenna 206 using suitable techniques. For example, the electronics module 205 and the RFID antenna 206 may be connected via an RF cable and RF connector assemblies.

FIG. 3 is a block diagram of an RFID tag used in accordance with some embodiments. The RFID tag 102 includes an antenna 302 and an integrated circuit 304. The antenna 302 is configured to receive and transmit RF signals. The integrated circuit 304 is configured to store and process information. The RFID tag 102 can be positioned within transmission range of the RFID reader 104. Accordingly, the RFID tag 102 can receive an interrogation signal sent from the RFID reader 104 via the antenna 302. The integrated circuit 304 can perform one or more operations in response to receiving the interrogation signal, including modulating the interrogation signal. After processing the interrogation signal, the RFID tag 102 can transmit a response signal to the RFID reader 104 through the antenna 302. Upon receipt of the response signal, the RFID reader 104 may extract information from the response signal and transmit the extracted information to a processor associated with an inventory management system.

As a person skilled in the art will immediately appreciate upon review of the present teachings, there are numerous establishments in which the RFID system 100 in accordance with the present teachings is applicable. For sake of brevity, many of the examples described herein refer to a retail establishment; however, such examples should no way be interpreted as limiting the scope of the present teachings to a retail establishment. In order for the RFID system of the present disclosure to detect an item being removed from an establishment without authorization, it also has to determine when an item is authorized for removal from the establishment. Two scenarios will now be described, by way of an example, of an item being authorized for removal from the establishment. In a first scenario, when an item is purchased from a retail establishment, a reader in a PoS system (referred to herein as the PoS reader 108) may deactivate the RFID tag affixed to the purchased item, thus altering information on the RFID tag to indicate that the item is authorized for removal from the establishment (e.g., changing a status bit to “sold”). In a second scenario, when an item is purchased from a retail establishment, the PoS reader 108 may choose not to deactivate the RFID tag affixed to the purchased item to indicate that the item is authorized for removal from the establishment, or may not be able to do so, due to, for example, limitations of the RFID tag, such as, the RFID tag may only comprise an EPC number for the item and/or not have an updatable memory. In this second scenario, the PoS reader 108 identifies an item identifier derived from the RFID tag affixed to the item and stores the item identifier on a separate RFID tag or other data carrier (herein referred to as an EAS pass) to indicate that the item is authorized for removal from the establishment in accordance with the present teachings of the disclosure. In this example, one or more readers 104 may be configured to cover an exit of the retail establishment so that RFID tags passing through the exit may send RF signals to the readers covering the exit. The reader(s) configured to cover the exit are referred to herein as EAS exit portal(s) 110. It should be noted that the PoS reader 108 and the EAS exit portal 110 may include the same components as other readers 104 in the system. Thus, in this example where both scenarios described above are possible in the establishment, as customers carry items through the exit, the EAS exit portal 110 is configured to interrogate a RFID tag affixed to an item that is being removed from the establishment, and attempts to interrogate an EAS pass, if found. The EAS exit portal is further configured to detect an unauthorized removal of the item by determining that the RFID tag affixed to the item being removed is not altered to indicate that the item is authorized for removal from the establishment, and that an item identifier derived from the RFID tag affixed to the item being removed from the establishment is not found on the outbound list of the EAS pass. In other words, if all the items being removed from the establishment are respectively affixed either to RFID tags that were deactivated by the PoS reader 108 or to RFID tags that are activated and listed on the EAS pass, the EAS exit portal 110 will not issue an alarm.

Let us now discuss the EAS pass in greater detail in accordance with the present teachings of the disclosure. The EAS pass may be an RFID tag or other data carrier with a specific set of data elements, written according to general or retailer-specific procedures to optimize EAS operations. The EAS pass 400 may be embodied in a variety of forms, for example, a disposable RFID tag, a reusable RFID tag, a bar code, or an electronic pass. More specifically, the EAS pass may be embodied in a hard-shell reusable tag that may be dropped into a kiosk slot after passing through EAS exit portal 110. The EAS pass 400 may also be embodied as an electronic pass, which may be embedded, for example, on a loyalty card. The EAS pass 400 may also be embodied as one or more bar codes printed on, for example, a sales receipt or disposable paper slip, printed as part of an authorizing transaction. For example, if the EAS exit portal in a retail establishment detects an unaltered RFID tag, a sign, or other indication, may prompt the customer (or store personnel) to scan the EAS pass. In this example, the EAS exit portal would only issue an alarm if the EAS pass does not list the item identifier of the item being removed, or if the customer tries to leave the establishment without scanning the EAS pass.

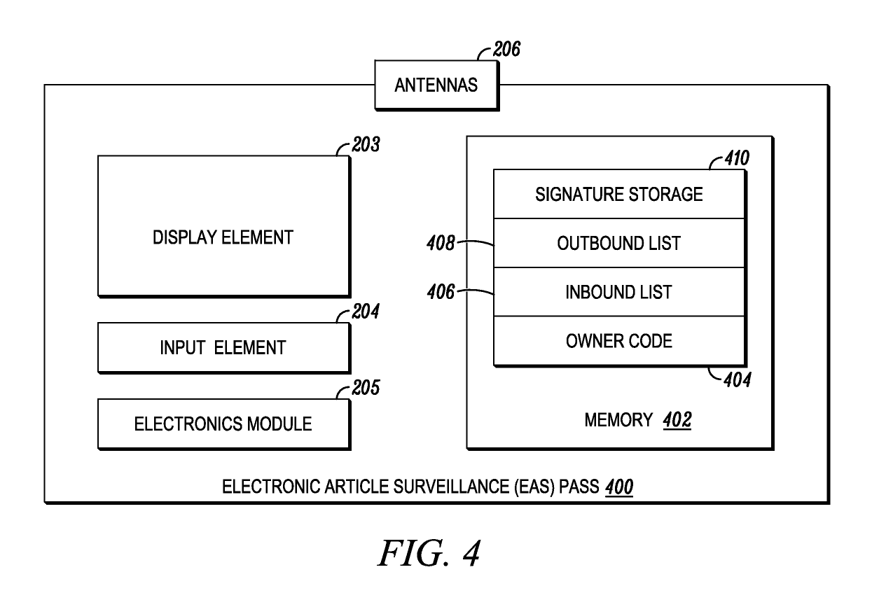

Turning now to FIG. 4, an exemplary block diagram of the EAS pass used in accordance with some embodiments of the present disclosure is illustrated. The EAS pass 400 may comprise a memory 402 for storing at least one of a digital signature 410, an owner code 404 for the establishment, an inbound list 406 used to store a set of identifiers derived from RFID tags that are affixed to items that are brought into the establishment, and/or an outbound list 408 used to store a set of item identifiers derived from RFID tags that are affixed to items authorized for removal from the establishment. The number of identifiers in the set of identifiers stored on both the inbound list and the outbound list can be zero or greater. The owner code 404 may be part of the establishment's serialized global trade item number (SGTIN), or may be, for example, a global location number for indicating a location of a particular establishment. The owner code 404 stored on the EAS pass 400 can be the same as the owner code stored on each item's RFID tag, so that the EAS exit portal 110 can perform one “select” operation to select both the EAS pass 400 and any unaltered RFID tag within its coverage area. The inbound list 406 may be used to store EPC numbers, or a portion of the EPC number (e.g., a serial number or a portion thereof) found on items brought into the establishment by individuals visiting the establishment. These items brought into the establishment may be “foreign” items purchased from another establishment or may be an item previously authorized for removal (e.g., sold) by the establishment. The outbound list 408 may be used to store zero or more item identifiers associated with zero or more items which, although authorized to be removed from the establishment (e.g., purchased), may have associated RFID tags which were not deactivated (marked as authorized for removal) by the reader (e.g., the PoS reader 108). Some of the blocks shown on FIG. 4 may or may not be utilized, depending on the embodiment of the EAS pass. For example, a disposable RFID tag is unlikely to comprise a display element 203, but may comprise the memory 402 and also may comprise the antenna 206 and electronics module 205, which perform the typical functions of RFID tags as described for blocks 302 and 304, respectively, of FIG. 3. When embodied as a bar code, however, the EAS pass comprises an optical storage medium for memory 402, and the other blocks of FIG. 4 are typically not present. When embodied as an electronic pass, such as a loyalty card, the EAS pass may comprise all blocks shown in FIG. 4.

In one embodiment, the EAS pass stores a digital signature 410 derived from a secret key associated with the establishment. In this embodiment, the EAS exit portal uses the digital signature to detect an unauthorized creation of a new EAS pass or an unauthorized modification to the EAS pass (e.g., an addition of an item identifier). Optionally, the digital signature is a result of a hash function derived from at least one of the owner code, the inbound list, or the outbound list.

In some embodiments, when a digital signature is used, the memory 402 may not need to be locked with, for example, a password, to detect an unauthorized modification to the memory 402 of the EAS pass. Alternatively, the establishment can choose to lock the memory 402 with a password, in which case, the digital signature may not be necessary. Additionally, to deter others from accessing information stored on the EAS pass 400, information stored on the EAS pass could be encrypted. Optionally, the EAS exit portal 110 could also be programmed to automatically erase at least a portion of the information stored on the EAS pass 400 after the information is read by the EAS exit portal 110.

The full encoding of an EPC number typically uses 96 bits, and so the inbound and outbound lists on memory 402 could potentially require a fairly large amount of memory. Thus, if information for RFID tags that were not deactivated exceeds the memory capacity of a single EAS pass 400, the information may be stored on two or more EAS passes by the PoS reader 108. The EAS exit portal 110 is configured to detect one or more EAS passes 400. Thus, upon detecting the EAS passes 400, the EAS exit portal 110 is configured to check the outbound list on each of the detected EAS passes 400 using procedures that are otherwise identical to when only a single EAS pass 400 is detected. However, an establishment can employ various techniques to optimize memory usage, when encoding an EAS pass 400. For example, the size of the outbound list may be reduced by storing only a portion of an item identifier (for example, by storing only the last two digits of each serial number) for RFID tags that were not deactivated at the PoS reader 108. In another example, when more than one of the same item is purchased, the outbound list 408 can simply include a quantity/SKU listing rather than repeatedly listing the same SKU (e.g., when four of the same towels are purchase, the outbound list 408 could list the quantity—four (4) and the SKU for the towels in one entry). In yet another example, foreign item (i.e., those items purchased elsewhere and brought into the establishment) need not be listed on the inbound list 406 if owner codes are listed on the foreign RFID tags.

It may be desirable for the EAS pass to have an identifier. In one embodiment, the identifier for the EAS pass may be standardized according to, for example, a version of an EPC Global UHF Gen 2 standard. In another example embodiment, the EAS pass may have an identifier that comprises a unique number or code associated with the particular establishment so as to distinguish it from a standard RFID tag affixed to an item sold by the establishment (if embodied as an RFID tag) and to distinguish it from another EAS pass used by another establishment. For example, the EAS pass may have an identifier that comprises an item reference for indicating that the EAS pass is a “pseudo-product” made by the establishment, as opposed to an item sold by the establishment. Alternatively, or in addition to, the EAS pass may have an identifier that comprises the SGTIN for the establishment. It should be noted that in some embodiments, the identifier for the EAS pass may be the only data element on the EAS pass that is created in a particular (e.g., standardized) data format to ensure that third parties do not mistake the EAS pass for an item RFID tag. It should also be noted that an unused EAS pass 400 may be pre-encoded with an EPC associated with the EAS passes from a particular establishment. Memory 402 of an unused EAS pass may also be pre-encoded with the owner code associated with the establishment. The pre-encoding may occur before distributing the unused EAS passes to the establishment's PoE locations or to PoS locations.

There are also various techniques that may be employed to minimize the likelihood of an individual being able to falsely reuse an EAS pass. For example, if the EAS pass has an identifier, the EAS exit portal may be configured to keep a record of the EAS passes it has read preventing the same EAS pass from being reused without detection. As a result, the EAS exit portal may detect an unauthorized reuse of an EAS tag based on the identifier used for the EAS pass. In another example, the PoS reader may be configured to add a date and/or time stamp to the EAS pass. Thus, if the exact date and/or time of a sales transaction is recorded as an additional data element on the EAS pass 400, it will be difficult to reuse the EAS pass 400 by exiting through the EAS exit portal 110, later re-entering the establishment, and again exiting through EAS exit portal 110 with additional items that are the same as those listed on EAS pass 400, without causing a detectable date and/or time discrepancy. As a result, the EAS exit portal may detect an unauthorized reuse of the EAS tag based on the date and/or time stamp stored on the EAS pass. In yet another example, when creating the outbound list 408, the PoS reader 108 can create a separate “hash” data element, from the serialized portions of identifiers derived from items that are authorized for removal, and record this “hash” (using a small number of bits), instead of recording all the serial numbers separately on the outbound list. It is unlikely that other items with the same SKU(s) will result in the same hash value. In still yet another example, if the outbound list stores only a portion of an item identifier (for example, by storing only the last two digits of each serial number) for RFID tags that were not deactivated at the PoS reader 108, it not only optimizes memory usage, as described above, but also eliminates subsequent unauthorized removal of additional items with the same SKU number. It will be difficult to find two of the same items whose serial numbers have the identical last two digits, especially because the EPC serial numbers for most items are not listed on the outer packaging.

In one embodiment, item RFID tags are never altered to indicate authorized removal from an establishment, and thus all items in a transaction are written to the outbound list 408 on the EAS pass(es) associated with the transaction. When the EAS exit portal 110 detects the EAS pass(s), the EAS exit portal 110 checks the outbound list 408 against a set of item RFID tags also detected by EAS exit portal 110, to determine whether unsold items are being removed. An alarm may be issued if the EAS exit portal 110 detects one or more activated RFID tags that are not listed on the EAS pass(es), or if there is no EAS pass found when attempting to interrogate the EAS pass in conjunction with activated RFID tags. The benefit of this approach is because there is no need to update the RFID tags, there is no need to lock/unlock memories on these tags, with, for example, passwords. In addition, the lowest-cost EPC-only tags that do not contain updatable memory can be used as item RFID tags (in which case, the EAS exit portal 110 interrogates all RFID tags passing through the portal, and considers an RFID tag as “unsold” if it does not appear on either the inbound or outbound lists of an EAS pass).

In some embodiments, the EAS pass 400 may provide a backup mechanism for overcoming deactivation failures at the PoS reader 108, which may occur when the establishment uses EAS methods that alter an item's RFID tag to indicate authorization for removal. In some embodiments, each item's RFID tag includes at least enough user memory to encode an “owner code” or store location for the establishment (to distinguish the establishment's RFID tag from other tags brought into the establishment), and each RFID tag must be writeable at the PoS system, to, for example, change the RFID tag status from “unsold” to “sold”. However, such implementations are susceptible to deactivation failures. Specifically, at the PoS system, a deactivation failure may be detected when the PoS reader 108 determines that the status of one or more RFID tags cannot be updated to show that the associated item was legitimately sold. Possible reasons for such failures may include, but are not limited to, (1) an incorrect owner code (e.g., store location for the establishment) on the RFID tag, (2) an incorrect tag password, (3) an erroneous lock being placed on the area of memory that needs to be update, or (4) if the RFID tag only contains an EPC number but no other writable memory. Regardless of the reason for the failure, the PoS reader 108 can write the EPC(s) of the problematic RFID tag(s) to the outbound list 408 of an EAS pass 400. Using this approach, all RFID tags associated with purchased items may be updated to indicate “sold” status, except for those RFID tags with deactivation failures. In this embodiment, foreign tags are automatically filtered out by their “foreign” owner codes (which show that the foreign tags were never included in the establishment's inventory). Therefore, the foreign tags do not necessarily need inbound detection and listing. Because of these characteristics, the number of un-altered RFID tags that might trigger a false alarm will be small, and so, depending on the system design, it may not be necessary to use information stored on the inbound list 406.

It is desirable to eliminate, or at least minimize, false alarms associated with inbound items (e.g., “foreign” items purchased elsewhere, or items previously authorized to be removed from the establishment (e.g., previously purchased items), and brought into the establishment that may still be wrapped in its RFID-tagged packaging or that may have RFID tags permanently affixed to them). In one embodiment to reduce the likelihood of a false alarm, the EAS exit portal 110 may be configured to have a copy of or access to the stock keeping unit (SKU) database for the establishment, and to determine that removal of an item from the establishment is authorized if the item identifier derived from the RFID tag affixed to the item being removed is not listed on the SKU database. The SKU database is a list of item make/model information in the inventory, but not specific serial numbers for each item. The SKU database is much smaller and more stable than an inventory database that includes every serialized item in the inventory. Thus, it is unlikely that foreign items brought into the establishment will be listed on the SKU database, thus reducing the likelihood for a false alarm.

In another embodiment to reduce the likelihood of a false alarm, the EAS exit portal 110 can be stocked with and/or have write-access to at least one EAS pass. When a customer carries items into the establishment that may trigger an alarm, the EAS exit portal 110 may provide an indication, for example, illuminate a sign, prompting the customer to obtain an EAS pass in order for the EAS exit portal to store the item identifiers for the items being carried into the establishment on the inbound list of the EAS pass. Storing the item identifiers on the inbound list may be accomplished by having the customer re-carry the items through the PoE with the obtained EAS pass, or alternatively, prior to bringing any items into the establishment, an EAS pass may be obtained before the items are carried through the PoE. If an item is purchased while in the establishment, the PoS reader 108 may store the tag identifier for the purchased item in the outbound list 408 of the same EAS pass (i.e., the EAS pass obtained during entry into the establishment). Using this approach, the unauthorized removal of stocked items (which would appear on neither the inbound list 406 nor the outbound list 408) would trigger the alarm.

It should be noted that the accuracy of segregating “inbound” reads from “outbound” reads on an EAS pass can be improved, by using, for example, dual antenna portals that are highly directional or physically spaced apart. Alternatively, the inbound/outbound direction can be established by simply adding photo-detectors or other object sensors to either side of a single PoE (a customer entering the PoE will interrupt the light beam to the photo-detector on the inbound or the outbound side of the PoE, but will not interrupt both simultaneously). In some embodiments, the inbound list 406 can be stored in the EAS exit portal 110 memory or another database, rather than being written to the EAS pass. This way, only the outbound list 408 of the EAS pass 400 will include information updated by the PoS reader. In these embodiments, there is no need to obtain an EAS pass during entry.

In addition to eliminating or minimizing the likelihood of a false alarm, it may also be desired to control whether the EAS exit portal 110 will issue an alarm or prompt a customer to present an EAS pass, even if the EAS exit portal correctly detected an item being removed from the establishment without authorization. For example, once the EAS exit portal 110 detects that an item is being removed from the establishment without authorization, the EAS exit portal may perform a price lookup of the item. If the price of the item unauthorized for removal is below a predefined threshold value, the EAS exit portal 110 may not issue an alarm. As a memory optimization technique, the transaction reader may be programmed to add an item's identifier to the outbound list, only if the item's value is above the threshold utilized at the exit portal to suppress the alarm for low-valued items.

To eliminate the need to maintain the inbound list 406, in some embodiments of the present disclosure, the EAS exit portal may be configured to access a “snapshot” copy of the establishment's inventory database (also referred to herein as a snapshot inventory database), and to determine that removal of an item from the establishment is authorized if an item identifier derived from a RFID tag affixed to the item being removed is not listed on the snapshot inventory database. In other words, if the item identifier derived from a RFID tag affixed to the item being removed is not listed on the snapshot inventory database, the item was brought in from outside the establishment. If, however, an item with an unaltered tag is found to be listed on the snapshot inventory database, the EAS exit portal will still consider the removal to be authorized if the item is also listed on the outbound list of the EAS pass. Thus, implementing the snapshot inventory database in accordance with the present teachings of the disclosure does not require a continuous connection to a real-time inventory database or real-time updating as items are sold, or authorized for removal, throughout the day. The snapshot inventory database is stored offline, either internal or external to the EAS exit portal, and updated periodically, for example, overnight to reflect the day's sales and new inventory.

It is important to note, however, that until the snapshot inventory database is updated to reflect, for example, new inventory received, the new inventory may be vulnerable to an unauthorized removal if it is both received and offered for sale before the snapshot inventory database used by the EAS exit portal 110 is updated. In other words, an item may not be listed in the snapshot inventory database, and therefore may falsely appear to be a foreign item sold by another establishment. An advance ship notice process can solve this problem, in that the snapshot inventory database can be updated before the new items actually arrive at the establishment. As a result, the EAS exit portal 110 snapshot inventory database will include current and expected items as part of its inventory. If the advance ship notice process is not implemented, to reduce the possibility of an unauthorized removal, the snapshot inventory database used by the EAS exit portal 110 could simply be updated more frequently. Alternatively, new inventory could be recorded on a separate EAS pass as the new inventory is offered for sale. This separate EAS pass could then be carried to the exit so that EAS exit portal 110 can obtain information associated with the new inventory and update its snapshot inventory database.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a Read Only Memory (ROM), a Programmable Read Only Memory (PROM), an Erasable Programmable Read Only Memory (EPROM), an Electrically Erasable Programmable Read Only Memory (EEPROM) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A method for detecting an item being removed from an establishment without authorization, the method comprising the steps of:
interrogating a radio frequency identification (RFID) tag affixed to an item that is being removed from the establishment;
attempting to interrogate an electronic article surveillance (EAS) pass having an outbound list that stores a set of item identifiers, wherein each item identifier on the outbound list is derived from a RFID tag that is affixed to an item that is authorized for removal; and
detecting an unauthorized removal of the item by determining that an item identifier derived from the RFID tag affixed to the item being removed from the establishment is not found on the outbound list of the EAS pass.

2. The method of claim 1, further comprising the step of detecting an unauthorized removal of the item by determining that the RFID tag affixed to the item being removed is not altered to indicate that the item is authorized for removal from the establishment.

3. The method of claim 2, wherein the step of detecting an unauthorized removal of the item comprises determining that the EAS pass was not found during the step of attempting to interrogate an EAS pass.

4. The method of claim 1, wherein the step of attempting to interrogate an EAS pass comprises reading the outbound list to identify the set of item identifiers stored on the outbound list and comparing the set of item identifiers stored on the outbound list to the item identifier derived from the RFID tag affixed to the item being removed from the establishment.

5. The method of claim 1, further comprising accessing a stock keeping unit database, wherein the step of detecting comprises determining that the item is authorized for removal if the item identifier derived from the RFID tag affixed to the item being removed is not listed on the stock keeping unit database.

6. The method of claim 1, further comprising storing an identifier derived from an RFID tag affixed to an item that is brought into the establishment on an inbound list.

7. The method of claim 1, further comprising accessing a snapshot inventory database, and wherein the step of detecting an unauthorized removal of the item comprises further determining that the item identifier derived from the RFID tag affixed to the item being removed is listed on the snapshot inventory database.

8. The method of claim 1, wherein the EAS pass is embodied as one of a disposable RFID tag, a reusable RFID tag, a bar code or an electronic pass.

9. A method for detecting removal of an item unauthorized for removal from an establishment, the method comprising the steps of:
storing, by a transacting reader, an item identifier derived from a radio frequency identification (RFID) tag affixed to an item authorized for removal on an outbound list of an electronic article surveillance (EAS) pass;
attempting to interrogate, by an EAS exit portal, the EAS pass and at least one RFID tag being removed from the establishment; and
detecting, by the EAS exit portal, removal of an item unauthorized for removal from the establishment by determining that an item identifier derived from the RFID tag affixed to the item unauthorized for removal is not found on the outbound list of the EAS pass.

10. The method of claim 9, further comprising the step of detecting, by the EAS exit portal, removal of an item unauthorized for removal from the establishment by determining that the RFID tag affixed to the item unauthorized for removal is not altered to indicate that the item is authorized for removal from the establishment.

11. The method of claim 9, wherein the step of storing further comprises storing at least a portion of a serial number associated with the RFID tag that is affixed to the item authorized for removal.

12. The method of claim 9, wherein the step of storing further comprises issuing an identifier for each EAS pass, and wherein the step of detecting removal of an item unauthorized for removal from the establishment is further determined by detecting an unauthorized reuse of the EAS tag based on the identifier for the EAS pass.

13. The method of claim 9, wherein the step of storing further comprises adding a time stamp to the EAS pass, and wherein the step of detecting removal of an item unauthorized for removal from the establishment is further determined by detecting an unauthorized reuse of the EAS tag based on the time stamp.

14. The method of claim 9, further comprising the steps of:
storing a digital signature derived from a secret key associated with the establishment; and
using the digital signature, by the EAS exit portal, to detect an unauthorized creation of a new EAS pass or an unauthorized modification to the EAS pass.

15. The method of claim 14, wherein the digital signature is a result of a hash function derived from at least one of an owner code for the establishment, an inbound list used to store a set of identifier derived from a RFID tag that is affixed to an item that is brought into the establishment, or the outbound list used to store a set of item identifiers derived from a RFID tag that is affixed to an item authorized for removal.

16. A system configured to detect a removal of an item unauthorized for removal from an establishment, the system comprising:
a transacting reader configured to store an item identifier derived from a radio frequency identification (RFID) tag affixed to an item authorized for removal on an outbound list of an electronic article surveillance (EAS) pass; and
an EAS exit portal configured to attempt interrogation of the EAS pass and at least one RFID tag being removed from the establishment, and to detect removal of an item unauthorized for removal from the establishment by determining that an item identifier derived from the RFID tag affixed to the item unauthorized for removal is not found on the outbound list of the EAS pass.

17. The system of claim 16, wherein the EAS exit portal is further configured to detect removal of an item unauthorized for removal from the establishment by determining that the RFID tag affixed to the item unauthorized for removal is not altered to indicate that the item is authorized for removal from the establishment,

18. The system of claim 17, wherein the EAS exit portal is further configured to detect removal of the item unauthorized for removal from the establishment when the EAS pass is not found during the attempted interrogation.

19. The system of claim 16, wherein the EAS pass has an identifier that includes a unique number associated with the establishment.

20. The system of claim 16, wherein the EAS pass comprises a memory for storing a digital signature, and wherein the digital signature is derived from a secret key associated with the establishment, and wherein the EAS exit portal is further configured to use the digital signature to detect an unauthorized creation of a new EAS pass or an unauthorized modification to the EAS pass.

21. The system of claim 20, wherein the memory further stores at least one of an owner code for the establishment, an inbound list used to store a set of identifier derived from a RFID tag that is affixed to an item that is brought into the establishment, or the outbound list used to store a set of item identifiers, each derived from a RFID tag that is affixed to an item authorized for removal, and wherein the digital signature is a result of hash function derived from at least one of an owner code, the inbound list or the outbound list.

22. The system of claim 16, wherein the EAS exit portal is further configured to access a stock keeping unit database, and wherein the EAS exit portal is further configured to determine that removal of an item from the establishment is authorized if the item identifier derived from the RFID tag affixed to the item being removed is not listed on the stock keeping unit database.

23. The system of claim 16, wherein the EAS exit portal is further configured to access a snapshot inventory database, and to determine that removal of an item from the establishment is authorized if a tag identifier derived from a RFID tag affixed to the item being removed is not listed on the snapshot inventory database.

24. The system of claim 16, wherein the EAS pass is embodied as one of a disposable RFID tag, a reusable RFID tag, a bar code or an electronic pass.
